(19) United States
(12) Patent Application Publication
(10) Pub. No.: US 2024/0157372 A1
(43) Pub. Date: May 16, 2024

(54) TRICHOME SEPARATION SYSTEM AND METHOD OF SEPARATING TRICHOMES FROM SOURCE PLANT MATERIAL

(71) Applicants: TTT Innovations LLC, Chatsworth, CA (US); Python Extraction Systems, LLC, Rochester Hills, MI (US)

(72) Inventors: Thomas Bruggemann, Woodland Hills, CA (US); Robert N. Wirtz, Royal Oak, MI (US)

(21) Appl. No.: 18/510,052

(22) Filed: Nov. 15, 2023

Related U.S. Application Data
(60) Provisional application No. 63/425,500, filed on Nov. 15, 2022.

(51) Int. Cl. B02C 23/10

(52) U.S. Cl. CPC B02C 23/10

(57) ABSTRACT

A trichome separation system and a method of separating trichomes from source plant material are provided. The trichome separation system and method serves to separate and collect trichomes in a manner that has proved more effective and efficient than past techniques, and in a manner that facilitates automated and continuous industrial and commercial scale production. Per varying implementations, the trichome separation system has a liquid nitrogen cooling conveyor, a grinder downstream thereof, and an agitation mechanism further downstream thereof. An inert freezing agent dispenser can also be provided in the trichome separation system.

### CROSS-REFERENCE TO RELATED APPLICATION

This application claims the benefit of U.S. Provisional Patent Application No. 63/425,500, filed Nov. 15, 2022.

### TECHNICAL FIELD

This disclosure relates generally to agricultural production equipment and production processes employed to separate trichomes from plants.

### BACKGROUND

Certain plants, such as cannabis plants, have proven beneficial for medicinal purposes and, where laws permit, are consumed in various ways for recreational purposes. Trichomes, in general, are fine outgrowths or appendages or the like on plants. In cannabis plants, for instance, kief is a powder-like product emanating from resinous trichomes that form on cannabis flowers and leaves. When sifted from the flowers and leaves, the trichomes become kief. Kief is frequently considered the most valuable part of cannabis plants. Sifting with screens is a common technique used for collecting kief from cannabis plants, among other collection techniques determined effective. But larger industrial and commercial scale production for effective and efficient collection of kief, as well as other types of trichomes, remains elusive.

### SUMMARY

In an embodiment, a trichome separation system may include a liquid nitrogen cooling conveyor, a grinder, and an agitation mechanism. Source plant material can be loaded in the liquid nitrogen cooling conveyor. Liquid nitrogen can be sprayed directly to the source plant material by way of the liquid nitrogen cooling conveyor. The grinder is situated downstream of the liquid nitrogen cooling conveyor. Cooled source plant material that exits the liquid nitrogen cooling conveyor can be received in the grinder. The agitation mechanism is situated downstream of the grinder. Ground source plant material that exits the grinder can be received in the agitation mechanism. Trichomes can be separated from the ground source plant material by way of the agitation mechanism.

In another embodiment, a method of separating trichomes from source plant material may include varying steps performed in varying orders. The method may involve loading source plant material in a liquid nitrogen cooling conveyor. Spraying liquid nitrogen to the source plant material by way of the liquid nitrogen cooling conveyor may also be provided in the method. Downstream of the liquid nitrogen cooling conveyor, the method may further involve delivering cooled source plant material by way of the liquid nitrogen cooling conveyor to a grinder. Grinding the cooled source plant material may also be provided in the method. Downstream of the grinder, the method may further involve delivering ground source plant material to an agitation mechanism. The agitation mechanism may separate trichomes from the ground source plant material.

### BRIEF DESCRIPTION OF THE DRAWINGS

The following detailed description of certain embodiments and best mode will be set forth with reference to the accompanying drawings, in which:

FIG. 1 is a schematic depiction of an embodiment of a trichome separation system; and

FIG. 2 is a flowchart of an embodiment of a method of separating trichomes from source plant material.

### DETAILED DESCRIPTION

The drawings and descriptions present embodiments of a trichome separation system 10 and embodiments of a method of separating trichomes from source plant material. The trichome separation system 10 is described as a kief separation system 10 per the embodiment herein, and the method of separating trichomes is described as a method of separating kief from cannabis source plant material per the embodiment herein; still, other trichomes from other source plant materials can be subject to the system and method set forth in this description in other embodiments. The kief separation system 10 and method separate and collect kief in a manner that is more effective and more efficient than past techniques of collecting kief. Past techniques are often smaller in scale and not readily suitable for mass-production. In contrast, the kief separation systems and methods described herein effect industrial and commercial scale production for the separation and collection of kief from cannabis source plant material in a way that is largely automated and continuous. Since the cannabis source plant material is brought to a frozen state and maintained therein in the kief separation systems and methods, as described below, the material can be processed in the kief separation system 10 soon after cutting the cannabis plants at harvesting time. The extensive physical space and lengthy duration needed in a typical cannabis plant drying procedure—one of the initial steps in certain harvesting processes—can hence be minimized or altogether avoided. Overall, a substantial gain in harvesting efficiencies is thus obtainable, while maintaining quality of the kief end product. Furthermore, as used herein, downstream refers to a direction in which cannabis source plant material is advanced through the kief separation system 10 from initial input to subsequent output, and upstream refers to a direction that is opposite the downstream direction.

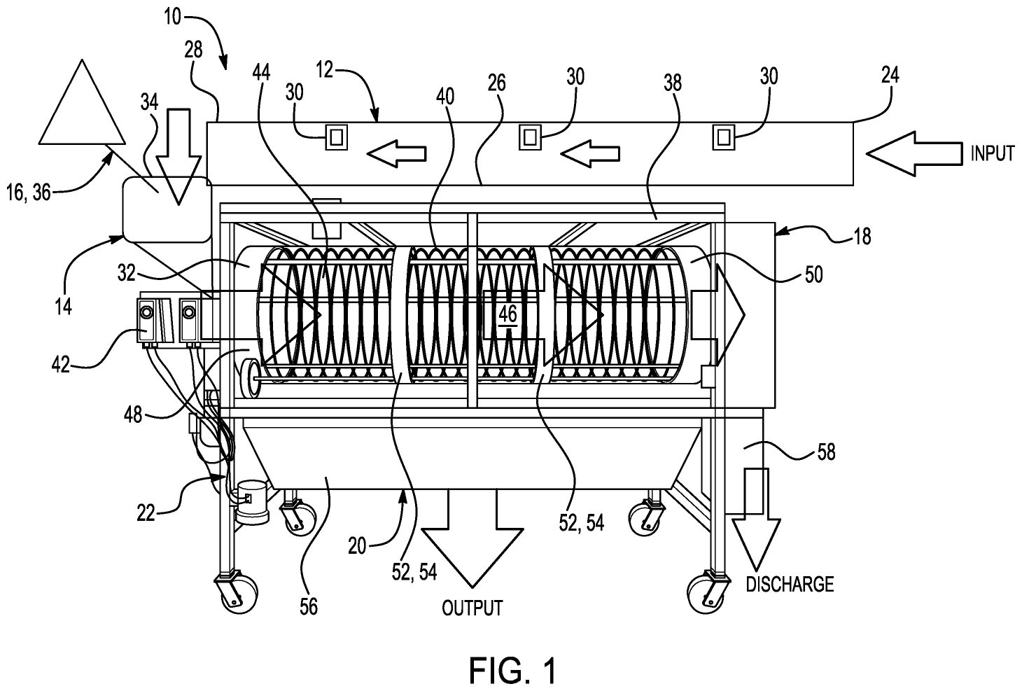

The kief separation system 10 can have different designs, constructions, and components in various embodiments, depending in part upon—among other possible factors—the desired quantity of cannabis source plant material to be subjected to kief separation in a batch and the intended amount of kief to be collected from cannabis source plant material batches. In the embodiment of FIG. 1, the kief separation system 10 is a machine and piece of floor-standing equipment that includes a liquid nitrogen (LN2) cooling conveyor 12, a grinder 14, an inert freezing agent dispenser 16, a trommel barrel 18, and a catch basin 20. These components are constituent parts that make-up the larger kief separation system 10. A frame 22 provides a support structure for the components, and provides connections among the components for an integrated and whole machine. From initial loading and to subsequent collection and final discharge, the general flow of the cannabis source plant material in the kief separation system 10 involves movement from the liquid nitrogen cooling conveyor 12, to the grinder 14, and then to the trommel barrel 18 where kief collects in the catch basin 20. The grinder 14 is hence situated downstream of the liquid nitrogen cooling conveyor 12, and the trommel barrel 18 is in turn situated downstream of the grinder 14. Still, the kief separation system 10 can have more, less, and/or different components in various embodiments; for example, a human-machine-interface (HMI) could be provided for operator management of the kief separation system 10, and a controller such as a programmable logic controller (PLC) could be provided for control and automation of the multiple components and stages of the kief separation system 10, as well as for control of certain parameters of the discrete components and stages.

The liquid nitrogen cooling conveyor 12—also known as a liquid nitrogen tunnel freezer—initially receives a batch of cannabis source plant material (or other source plant material in other embodiments) in the kief separation system 10 and machine, and serves to flash freeze the cannabis source plant material. This occurrence of freezing constitutes a primary stage of cooling in the larger kief separation system 10 and method. The cannabis source plant material can be brought to an embrittled state via the liquid nitrogen cooling conveyor 12. Successive batches can be loaded in the liquid nitrogen cooling conveyor 12 in a somewhat uninterrupted manner, if desired. The cannabis source plant material can be taken immediately from a cannabis field or location of growth where the cannabis source plant material is cut and then transported to the kief separation system 10 and loaded into the liquid nitrogen cooling conveyor 12. Prior to loading, in an example, the cannabis could be subjected to a bucking procedure. Unlike past techniques of collecting kief, the cannabis source plant need not undergo a drying procedure beforehand, and rather can be loaded into the liquid nitrogen cooling conveyor 12 in an undried condition. The extensive physical space and lengthy duration in a typical drying procedure—which can involve large dedicated areas and countless drying racks—can hence be eschewed with use of the kief separation system 10 and machine.

In construction, the liquid nitrogen cooling conveyor 12 is installed atop the trommel barrel 18 and mounted thereon, per this embodiment; still, other installation configurations are possible in other embodiments. When situated atop the trommel barrel 18, a more efficient overall construction of the kief separation system 10 is exhibited, it has been shown, and a more efficient overall processing of the cannabis source plant material is achievable, according to this embodiment. A batch of cannabis source plant material, or other source plant material, is loaded and placed in the liquid nitrogen cooling conveyor 12 at an input end 24 thereof. An enclosure with walls can close-off an interior of the liquid nitrogen cooling conveyor 12 from the exterior environment, per an embodiment. The batch of cannabis source plant material can be placed on a conveyor 26 upon its loading and entry. The conveyor 26 can be a steel mesh belt conveyor, or some other suitable type of conveyor. The conveyor 26 carries and transports the batch from the input end 24 and to an output end 28 of the liquid nitrogen cooling conveyor 12. The batch of cannabis source plant material is cryogenically frozen in the liquid nitrogen cooling conveyor 12. Over its traversal, liquid nitrogen (LN2) is sprayed and applied directly to the batch of cannabis source plant material, subjecting the material to extremely cold temperatures of negative 196 degrees Celsius (−196° C.) and inducing flash freezing of the material. The liquid nitrogen can be sprayed and discharged from a multitude of nozzles 30 equipped in the liquid nitrogen cooling conveyor 12 and aimed at various orientations toward the traversed material. The liquid nitrogen can make direct contact with, and applied directly to, the cannabis source plant material being transported through the liquid nitrogen cooling conveyor 12. At the output end 28, the cannabis source plant material is in a frozen and cooled state and is delivered to the grinder 14.

The grinder 14 receives the cooled cannabis source plant material that exits the liquid nitrogen cooling conveyor 12 and serves to breakdown larger-sized cannabis material into smaller-sized and finer particles and bits. The grinder 14 can be installed and mounted near the output end 28 of the liquid nitrogen cooling conveyor 12, and near an inlet end 32 of the trommel barrel 18 at a sidewall thereof. The grinder 14, according to the embodiment of FIG. 1, is mounted at a direct side of the liquid nitrogen cooling conveyor 12 and at a direct side of the trommel barrel 18; it has been shown that such side-mounting furnishes a more efficient overall construction of the kief separation system 10 and provides a more efficient overall processing of the cannabis source plant material. Still, other installation and mounting configurations are possible in other embodiments. An inlet opening 34 of the grinder 14 can accept the cooled cannabis source plant material coming off of the conveyor 26, according to an embodiment. Different types of grinders can be provided in different embodiments. In one example, the grinder 14 is of the dual-shaft and knife-style grinder type; still, grinders of other designs and constructions and types are possible in other examples.

The inert freezing agent dispenser 16 serves to maintain the cooled cannabis source plant material in its cooled state immediately after the liquid nitrogen cooling conveyor 12 and prior to, and amid, the grinding stage. An undue rise in temperature is hence precluded, and grinding can be performed at subzero temperatures, per this embodiment. This occurrence of maintaining the cooled state constitutes a secondary stage of cooling in the larger kief separation system 10 and method. The inert freezing agent dispenser 16 applies an inert freezing agent directly with, and/or to, the cooled cannabis source plant material. The inert freezing agent can be liquid nitrogen (LN2), liquid carbon dioxide (CO2), or dry ice, as but a few examples. The inert freezing agent dispenser 16 can take different forms in different embodiments, depending at least in part upon the inert freezing agent desired and implemented for employment at this stage in the kief separation system 10.

In one embodiment, the inert freezing agent dispenser 16 is a dry ice supply and dispenser 36. In an example, the dry ice supply 36 is a container that holds dry ice and dispenses the dry ice directly into the inlet opening 34 of the grinder 14 in a controlled manner, and together and concurrently with the received cooled cannabis source plant material. In another example, the dry ice supply 36 is a dry ice production machine that makes dry ice on-demand in a controlled manner; again here, the produced dry ice can be dispensed directly into the grinder's inlet opening 34 and together and concurrently with the received cooled cannabis source plant material. The dry ice and cooled cannabis source plant material can be combined together at the grinder 14 as the grinding takes place. The dry ice itself can take different forms—often dependent on how it is supplied—including in the form of dry ice pellets. In another embodiment, the inert freezing agent dispenser 16 is a tank or other dispensing device or container that is equipped to spray and discharge liquid nitrogen (LN2) or liquid carbon dioxide (CO2). The spray can be aimed directly at the cooled cannabis source plant material amid or after reception at the inlet opening 34 of the grinder 14 and/or as cooled cannabis source plant material exits the output end 28 of the liquid nitrogen cooling conveyor 12.

The trommel barrel 18 receives the ground and cooled cannabis source plant material that exits the grinder 14 and serves to gently tumble and excite movement of the material to ultimately yield separated kief from the material (in other embodiments, separated trichomes are yielded). Ground and cooled cannabis source plant material is delivered from an output of the grinder 14 and to the inlet end 32 of the trommel barrel 18. The trommel barrel 18 can have different designs, constructions, and components in various embodiments. In the embodiment of FIG. 1, the trommel barrel 18 includes a housing 38, a cylindrical drum 40, a motor 42, and a netting 44; still, the trommel barrel 18 could have more, less, and/or different components in other embodiments.

The housing 38 provides structural support for other components of the trommel barrel 18. The drum 40 is driven to rotate about its center axis by the motor 42 amid use of the kief separation system 10. The motor 42 can be an electric type of motor, per an embodiment, and can have a connection to a central axle of the drum 40. Rotation of the drum 40 causes the tumbling action of the cannabis source plant material (or other source plant material) which works to spur dislodgement of kief (or other trichomes) therefrom. Ground and cooled cannabis source plant material is tumbled and moved in an axial direction through an interior 46 of the drum 40 from a first end 48 and to a second end 50 thereof. In order to sectionalize the drum 40 into somewhat discrete interior sections and help control the rate of movement of the cannabis source plant material from the first end 48 to the second end 50, one or more baffles 52 can be equipped at the interior 46, per various embodiments. When more than one baffle 52 is provided, the baffles 52 can be spaced axially apart from one another. The baffles 52 impede and slow the axial movement of the cannabis source plant material from the first end 48 and to the second end 50, providing an increased duration of the material within the trommel barrel 18 and hence greater opportunity for the separation of kief from the cannabis source plant material subject to tumbling. The baffles 52 can have various designs and constructions. In an example, the baffle 52 includes a cylindrical wall 54 and one or more inboardly-extending walls (inboardly used relative to the cylindrical wall) that obstruct less-than-the-whole inboard area residing radially-inwardly of the cylindrical wall 54. The inboardly-extending walls obstruct passage of the cannabis source plant material, while an opening at the inboard area of the cylindrical wall 54 permits passage of the cannabis source plant material therethrough and from one section of the interior 46 to the next.

Moreover, in embodiments in which dry ice is supplied at the grinder 14, it has been found that enhanced coverage of the dry ice on the cannabis source plant material, or other source plant material, occurs as a result of grinding the dry ice with the material via the grinder 12, and then tumbling the ground dry ice with the material via the trommel barrel 18. Such enhanced coverage, while not strictly necessary in a given embodiment, has been shown to facilitate separation and collection of kief in a more efficient and effective manner than past procedures.

The netting 44 serves to sieve kief from the cannabis source plant material, and permits passage of the kief to the catch basin 20, while largely or wholly precluding passage of the residual flowers and leaves and other non-kief residual of the material. Separated kief falls through the netting 44. The netting 44 is securely held fully around the circumference of the drum 40 and with a full axial extent between the first and second ends 48, 50. The netting 44 covers and encloses the whole external periphery of the drum 40. The netting 44 can have various designs and constructions. Its material composition and size of open passages can vary according to, among other potential factors, the trichomes subject to sieving. In different examples, the netting 44 can exhibit a mesh-like or screen-like structure, and can be made of nylon, polyester, plastic, metal, or some other material. Open passages residing throughout the netting 44 that permit the passage of kief can range in size from approximately one-hundred-and-fifty (150) microns to two-hundred-and-fifty (250) microns, or can possess some other dimension. Still, other materials and other sizes are possible in other embodiments. The netting 44 can have a flexible form or a more rigid form, dictated mostly on its material and construction.

Still, in other embodiments, the kief separation system 10 can employ other measures and machines to excite movement of the ground and cooled cannabis source plant material to ultimately yield separated kief from the material, other than the trommel barrel 18. In lieu of the trommel barrel 18, an agitation mechanism could be provided downstream of the grinder 14. The agitation mechanism can serve a similar function as the trommel barrel 18, and, in this sense, the trommel barrel 18 can be a type and species of agitation mechanism. The agitation mechanism could take various forms in different embodiments. Depending on its form, the agitation mechanism could impart differing kinds of forcible agitation and movement to the ground and cooled cannabis source plant material including, but not limited to, vibratory motion, gyratory motion, reciprocal motion, oscillating motion, and sieving. In at some of its forms, the agitation mechanism could include an agitation motor and a screen or netting as some of its components.

The catch basin 20 serves to collect kief (or other trichomes) that passes through the netting 44. Kief that falls through the netting 44 is caught in the catch basin 20. The catch basin 20 can have a containment construction with a multitude of walls 56. An open top accepts fallen kief. The catch basin 20 can be sloped toward a single exit to encourage migration of the caught kief to a final collection location. Furthermore, in some embodiments, an auger may be equipped for steady rotation at a bottom of the catch basin 20 in order to aid movement of the caught kief to the final collection location. The motor 42 could cause rotation of the auger via a gear and axle assemble transferring rotation therefrom. In all, it is estimated that as much as 30-35% of the original and initial batch of cannabis source plant material will be separated and collected as kief amid use of the kief separation system 10 and method. Residual cannabis material that does not pass through the netting 44 and remains uncollected, travels the full longitudinal length of the trommel barrel 18 and interior 46 and exits the drum 40 at the second end 50 which can be outfitted with a chute 58 to facilitate gathering of same. The residual cannabis material can have further utilization in subsequent cannabis processing and products.

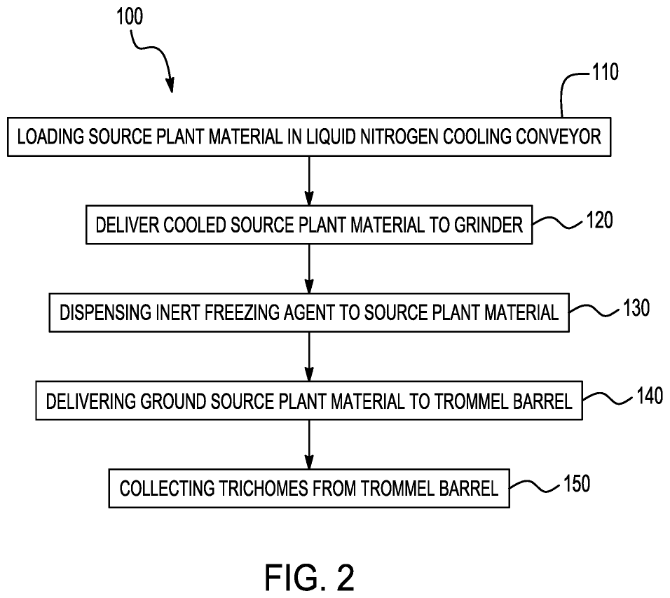

FIG. 2 is a flowchart that presents an embodiment of a method 100 of separating kief (or other trichomes) from cannabis source plant material (or other source plant material). The method 100 involves several steps that are performed in successive stages. More, less, and/or different steps can be performed in other embodiments of the method 100 of separating kief from cannabis source plant material than will be described with reference to FIG. 2. The method 100 can be performed with the kief separation system 10 according to this embodiment. In a first step 110, cannabis source plant material is loaded into the liquid nitrogen cooling conveyor 12. In a second step 120, which takes place downstream of the liquid nitrogen cooling conveyor 12, cooled cannabis source plant material is delivered to the grinder 14. In a third step 130, which can take place concurrently with the delivery of the second step 120, an inert freezing agent is dispensed to the cooled cannabis source plant material. The third step 130 can be carried out downstream of the liquid nitrogen cooling conveyor 12 and upstream of the grinder 14, per an embodiment. In a fourth step 140, which takes place downstream of the grinder 14, ground cannabis source plant material is delivered to the trommel barrel 18. In a fifth step 150, separated kief is collected from the trommel barrel 18 in the catch basin 20. Still, other steps can involve one or more of the following: conveying the cannabis source plant material through the liquid nitrogen cooling conveyor 12, spraying liquid nitrogen (LN2) to the conveyed cannabis source plant material, spraying the inert freezing agent on the cooled cannabis source plant material, supplying dry ice with the cooled cannabis source plant material at the grinder 14, and/or rotating the trommel barrel 18. Still, another embodiment of the method 100 of separating kief from cannabis source plant material can involve—among other potential steps set forth elsewhere—freezing cannabis source plant material, grinding the frozen cannabis source plant material, and agitating the ground cannabis source plant material.

It has been found that bringing the cannabis source plant material to a frozen state and largely or wholly maintaining that state in the kief separation system 10 and method greatly augments the effectiveness and efficiencies of kief separation and collection. The cooled cannabis source plant material has been shown to be more readily ground and more readily screened in the kief separation system 10 and method. In contrast, separating and collecting kief when cannabis source plant material is at ambient temperatures—and without the freezing and cooling measures of the kief separation system 10 and method—has proven difficult due to the often pasty and somewhat sticky nature of the material at such temperatures. Past efforts have been impeded by unwanted obstructed material movement and clogging at various places. Frozen and cooled cannabis source plant material, on the other hand, facilitates its handling and movement in the kief separation system 10 and method, especially amid agitation and, per the embodiment of the figures, at the trommel barrel 18 and through the netting 44.

As used herein, the terms “general” and “generally” and “substantially” are intended to account for the inherent degree of variance and imprecision that is often attributed to, and often accompanies, any design and manufacturing process, including engineering tolerances—and without deviation from the relevant functionality and intended outcome—such that mathematical precision and exactitude is not implied and, in some instances, is not possible. In other instances, the terms “general” and “generally” and “substantially” are intended to represent the inherent degree of uncertainty that is often attributed to any quantitative comparison, value, and measurement calculation, or other representation.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A trichome separation system, the system comprising:
a liquid nitrogen cooling conveyor, source plant material loadable in said liquid nitrogen cooling conveyor, liquid nitrogen sprayable directly to the source plant material via said liquid nitrogen cooling conveyor;
a grinder situated downstream of said liquid nitrogen cooling conveyor, cooled source plant material exiting said liquid nitrogen cooling conveyor is receivable in said grinder; and
an agitation mechanism situated downstream of said grinder, ground source plant material exiting said grinder is receivable in said agitation mechanism, trichomes separatable from the ground source plant material via said agitation mechanism.

2. The trichome separation system as set forth in claim 1, further comprising an inert freezing agent dispenser situated at least adjacent said grinder, an inert freezing agent dispensable at said grinder from said inert freezing agent dispenser and to the cooled source plant material received in said grinder.

3. The trichome separation system as set forth in claim 2, wherein said inert freezing agent dispenser is a dry ice supply, dry ice dispensable directly into an inlet opening of said grinder via said dry ice supply and to the cooled source plant material.

4. The trichome separation system as set forth in claim 1, wherein said liquid nitrogen cooling conveyor is mounted atop said agitation mechanism, and said grinder is mounted at a side of said liquid nitrogen cooling conveyor and at a side of said agitation mechanism.

5. The trichome separation system as set forth in claim 1, further comprising a catch basin located beneath said agitation mechanism, separated trichomes via said agitation mechanism collectible in said catch basin.

6. The trichome separation system as set forth in claim 1, further comprising:
an inert freezing agent dispenser situated at least adjacent said grinder, an inert freezing agent dispensable at said grinder from said inert freezing agent dispenser and to the cooled source plant material received in said grinder; and
a catch basin located beneath said agitation mechanism, separated trichomes via said agitation mechanism collectible in said catch basin;
wherein said liquid nitrogen cooling conveyor is mounted atop said agitation mechanism, and said grinder is mounted at a side of said liquid nitrogen cooling conveyor and at a side of said agitation mechanism.

7. The trichome separation system as set forth in claim 1, wherein said agitation mechanism is a trommel barrel.

8. A method of separating trichomes from source plant material, the method comprising:
loading source plant material in a liquid nitrogen cooling conveyor, spraying liquid nitrogen to the source plant material via said liquid nitrogen cooling conveyor;
downstream of said liquid nitrogen cooling conveyor, delivering cooled source plant material via said liquid nitrogen cooling conveyor to a grinder, said grinder grinding the cooled source plant material; and
downstream of said grinder, delivering ground source plant material to an agitation mechanism, said agitation mechanism separating trichomes from the ground source plant material.

9. The method of separating trichomes from source plant material as set forth in claim 8, further comprising dispensing an inert freezing agent to the cooled source plant material downstream of said liquid nitrogen cooling conveyor and upstream of said grinder.

10. The method of separating trichomes from source plant material as set forth in claim 9, wherein said inert freezing agent enters said grinder concurrently with the cooled source plant material and is subject to grinding via said grinder.

11. The method of separating trichomes from source plant material as set forth in claim 8, wherein said agitation mechanism is a trommel barrel, the method further comprising rotating said trommel barrel and collecting trichomes that pass through a netting of said trommel barrel.

12. The method of separating trichomes from source plant material as set forth in claim 8, further comprising supplying dry ice to the cooled source plant material in said grinder and downstream of said liquid nitrogen cooling conveyor.

13. The method of separating trichomes from source plant material as set forth in claim 12, further comprising grinding the supplied dry ice via said grinder concurrently with grinding of the cooled source plant material via said grinder.

14. The method of separating trichomes from source plant material as set forth in claim 9, further comprising maintaining the source plant material in a cooled state amid the method and to delivery to said agitation mechanism, the cooled state maintained via the spraying of liquid nitrogen to the source plant material and via the dispensing of inert freezing agent to the cooled source plant material.

15. The method of separating trichomes from source plant material as set forth in claim 8, further comprising:
dispensing an inert freezing agent to the cooled source plant material downstream of said liquid nitrogen cooling conveyor and upstream of said grinder, wherein said inert freezing agent enters said grinder concurrently with the cooled source plant material and is subject to grinding via said grinder;
wherein said agitation mechanism is a trommel barrel, rotating said trommel barrel and collecting trichomes that pass through a netting of said trommel barrel; and
maintaining the source plant material in a cooled state amid the method and to delivery to said trommel barrel, the cooled state maintained via the spraying of liquid nitrogen to the source plant material and via the dispensing of inert freezing agent to the cooled source plant material.
